(19) United States
(12) Patent Application Publication
(10) Pub. No.: US 2007/0139760 A1
(43) Pub. Date: Jun. 21, 2007

(54) Optical path length adjuster

(75) Inventors: Levinus P. Baker, Helmond (NL); Bart A. Salters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,019

(22) PCT Filed: Feb. 17, 2005
(86) PCT No.: PCT/IB05/50593

§ 371 Date: Aug. 16, 2006

(30) Foreign Application Priority Data
Feb. 21, 2004 (GB) 0403933.5

(51) Int. Cl. G02F 1/29

(52) U.S. Cl. 359/320; 359/296

(57) ABSTRACT

An optical path length adjuster (53) enables electro-optical control of a physical path length between two optical elements, suitable for use in the adjustment of an optical path length within three dimensional display devices that generate a virtual image within a defined imaging volume. The adjuster varies an optical path length between an input optical path and an output optical path and includes: a plurality of first optical (61) elements and second optical elements arranged in alternating sequence along an optical path, each first optical element (62) for determining a polarisation state of a light beam passing through that element and each second optical element for selectively transmitting or reflecting a light beam incident on that element depending on the selected polarisation state of the incident light beam, wherein the optical path length traversed by an input beam on the optical path can be varied by is selecting a particular second optical element at which reflection of the input beam is to occur, the reflected input beam emerging along the output optical path.

The present invention relates to methods and apparatus for adjusting an optical path length between two optical elements. In particular, though not exclusively, the invention relates to adjustment of an optical path length within three dimensional display devices that generate a virtual image within a defined imaging volume.

A three-dimensional image can be created in several ways. For instance, in stereoscopic displays two pictures uniquely observable by each of a viewer's eyes can be shown simultaneously or time-multiplexed. The pictures are selected by means of special spectacles or goggles worn by the viewer. In the former case, the spectacles may be equipped with Polaroid lenses. In the latter case, the spectacles may be equipped with electronically controlled shutters. These types of displays are relatively simple to construct and have a low data-rate. However, the use of special viewing spectacles is inconvenient and the lack of motion parallax may result in discomfort among viewers.

A more realistic three-dimensional impression can be created using an auto-stereoscopic display. In these types of display, every pixel emits light with different intensities in different viewing directions. The number of viewing directions should be sufficiently large that each of the viewer's eyes sees a different picture. These types of display show a realistic motion parallax; if the viewer's head moves, the view changes accordingly.

Most of these types of display are technically difficult to realise in practice. Several proposals can be found in the literature, see for instance U.S. Pat. No. 5,969,850. The advantage of these displays is that a number of viewers can watch, e.g. a single 3D television display without special viewing spectacles and each viewer can see a realistic three-dimensional picture including parallax and perspective.

Another type of 3D display is a volumetric display as described at http://www.cs.berkley.edu/jfc/MURI/LC-display. In a volumetric display, points in an image display volume emit light. In this way, an image of a three dimensional object can be created. A disadvantage of this technique is occlusion, i.e. it is not possible to block the light of points that are hidden by other objects. So, every object displayed is transparent. In principle, this problem can be overcome by means of video-processing and possibly tracking of the position of the viewer's head or eyes.

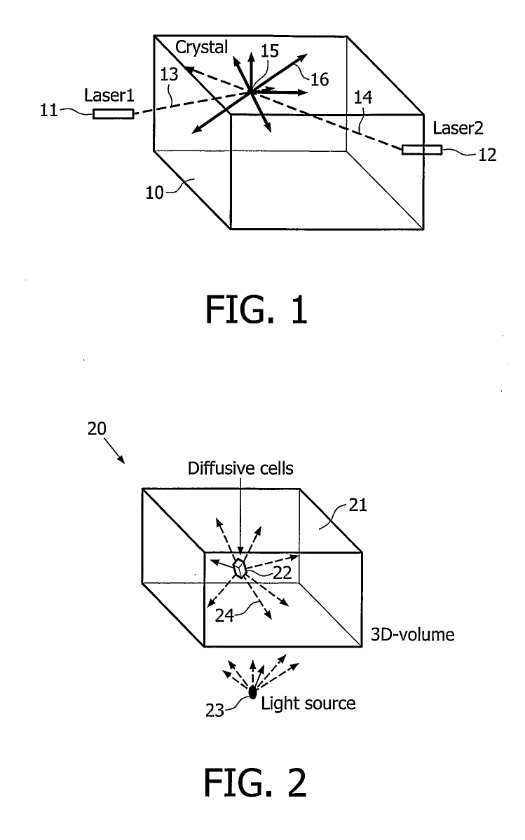

A known embodiment of a volumetric display is shown in FIG. 1. The display consists of a transparent crystal 10 in which two lasers 11, 12 (or more) are scanning. At the position 15 of intersection of the laser beams 13, 14, light 16 may be generated by up-conversion, where photon emission at a higher energy occurs by absorption of multiple photons of lower energy (i.e. from the combined laser beams). This type of display is expensive and complicated. A special crystal 10 and two scanning lasers 11, 12 are required. In addition, up-conversion is not a very efficient process.

An alternative embodiment of volumetric display 20 is shown in FIG. 2. This arrangement uses a material that can be switched between transparent and diffusive, such as polymer dispersed liquid crystal (PDLC) or liquid crystal gel (LC-gel). In a three-dimensional grid volume 21, cells 22 can be switched between these two states. Typically, the volume 21 is illuminated from one direction. In the illustration, the illumination source 23 is located below the grid volume. If a cell 22 is switched to a diffusive condition, light 24 is scattered in all directions.

One object of the present invention is to provide a volumetric three-dimensional image display device that overcomes some or all of the problems associated with prior art devices.

Another object of the present invention is to provide an apparatus suitable for adjusting an optical path length between two optical elements within a volumetric three-dimensional image display device.

A further object of the present invention to provide an optical path length adjuster for varying an optical path length between an input optical path and an output optical path.

Some or all of these objects may be achieved by embodiments of the invention as described herein.

According to one aspect, the present invention provides an optical path length adjuster for varying an optical path length between an input optical path and an output optical path, comprising:
a plurality of first optical elements and second optical elements arranged in alternating sequence along an optical path, each first optical element for determining a polarisation state of a light beam passing through that element and each second optical element for selectively transmitting or reflecting a light beam incident on that element depending on the selected polarisation state of the incident light beam,
wherein the optical path length traversed by an input beam on the optical path can be varied by selecting a particular second optical element at which reflection of the input beam is to occur, the reflected input beam emerging along the output optical path.

According to another aspect, the present invention provides a display device for generating a three-dimensional volumetric image, comprising:
a two-dimensional image display panel for generating a two-dimensional image;
a first focusing element for projecting the two-dimensional image to a virtual image in an imaging volume; and
means for altering the effective optical path length between the display panel and the projecting first focusing element so as to alter the position of the virtual image within the imaging volume, wherein the means for altering the effective optical path length comprises the optical path length adjuster as defined above.

According to another aspect, the present invention provides a method for varying an optical path length between an input optical path and an output optical path of an optical path length adjuster, comprising the steps of:
providing an input beam of light on the input optical path and passing it into a plurality of first optical elements and second optical elements arranged in alternating sequence along the optical path;
determining a polarisation state of the input beam at each first optical element through which the beam passes; and
either transmitting or reflecting the beam at each second optical element on which the beam is incident, depending on the selected polarisation state of the incident beam;
wherein the optical path length traversed by the input beam on the optical path can be varied by selecting a particular second optical element at which reflection of the input beam is to occur, the reflected input beam emerging along the output optical path.

According to another aspect, the present invention provides a method for generating a three-dimensional volumetric image, comprising the steps of:
generating a two-dimensional image on a two-dimensional image display panel;
projecting the two-dimensional image to a virtual image in an imaging volume with a first focusing element; and
altering the optical path length between the display panel and the projecting focusing element so as to vary the position of the virtual image within the imaging volume according to the path length adjusting method as defined above.

Embodiments of the present invention will now be described by way of example and with reference to the accompanying drawings in which:

FIG. 1 shows a perspective schematic view of a volumetric display based on two scanning lasers and an up-conversion crystal;

FIG. 2 shows a perspective schematic view of a volumetric display based on switchable cells of polymer dispersed liquid crystal or liquid crystal gel;

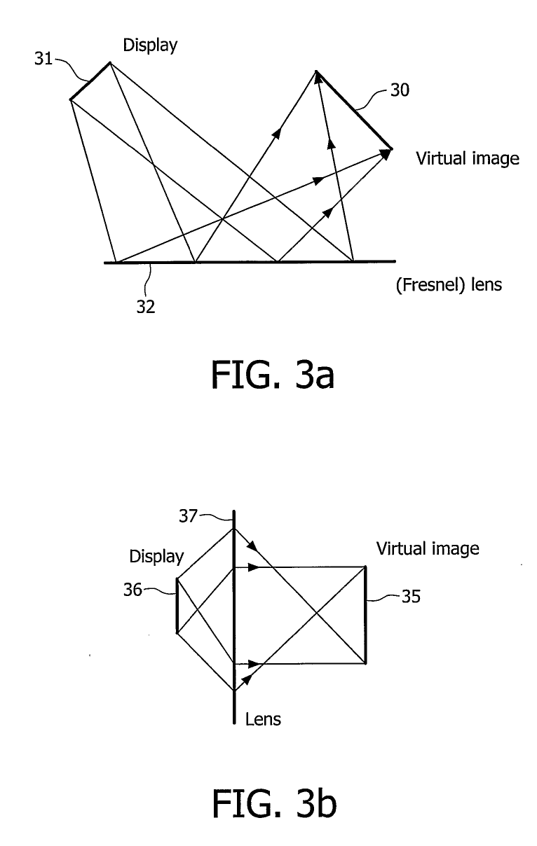

FIG. 3 is a schematic diagram useful in explaining the principles of a volumetric three-dimensional image display device in which the present invention may usefully be deployed;

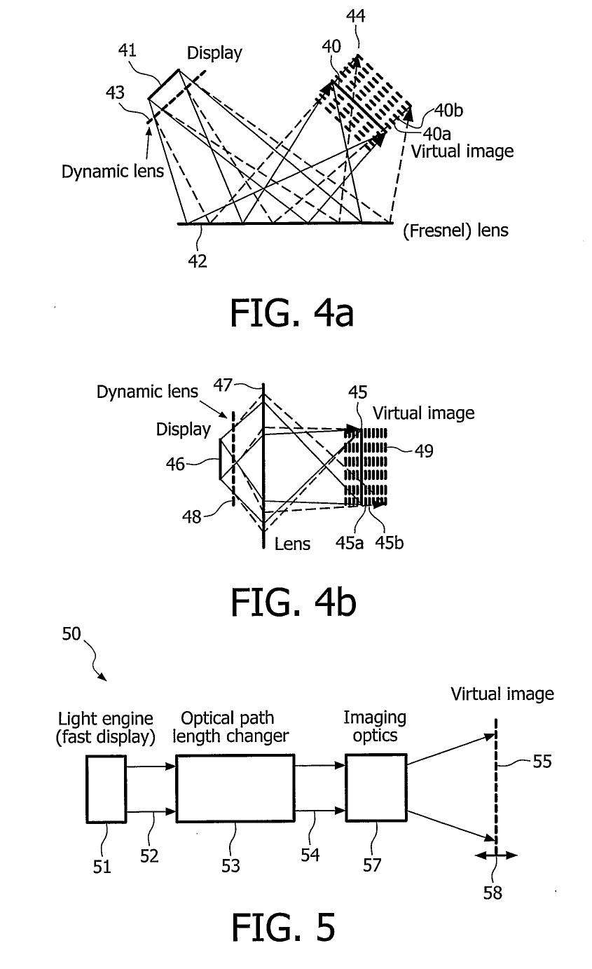

FIG. 4 is a schematic diagram illustrating volumetric three-dimensional image display devices comprising a display panel and an optical path length adjuster according to the present invention;

FIG. 5 is a schematic diagram of a volumetric three-dimensional image display device using an optical path length adjuster between a display panel and a focusing element;

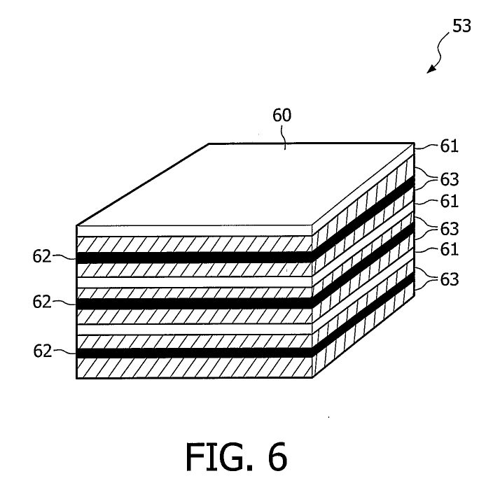

FIG. 6 shows a perspective schematic view of an optical path length adjuster according to the present invention;

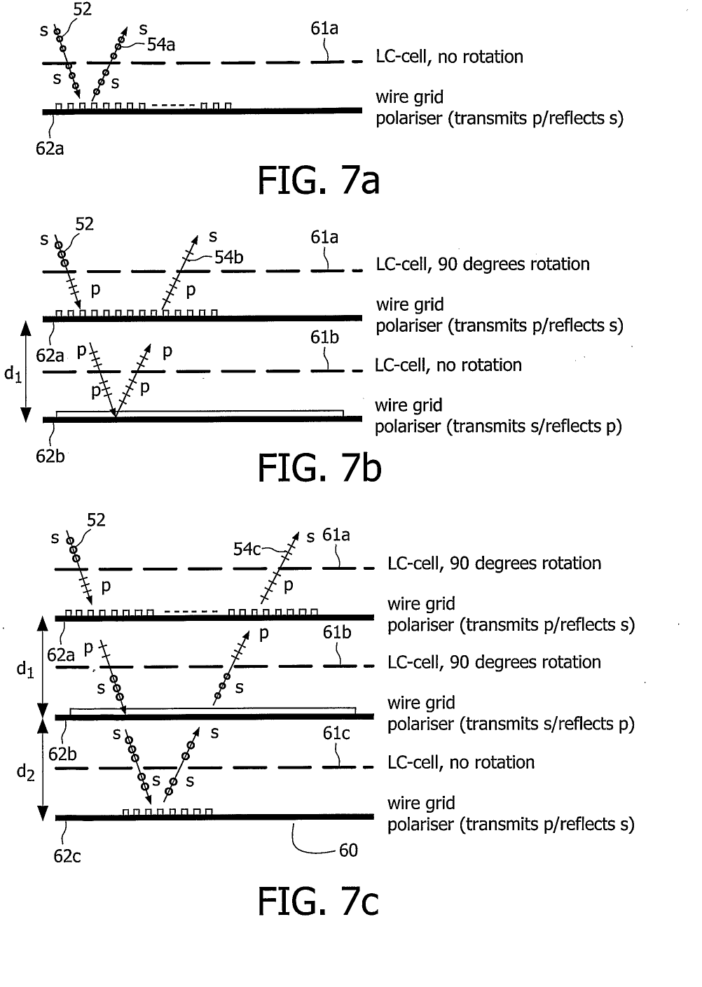

FIG. 7 is a schematic diagram illustrating the three different optical paths of the adjuster of FIG. 6;

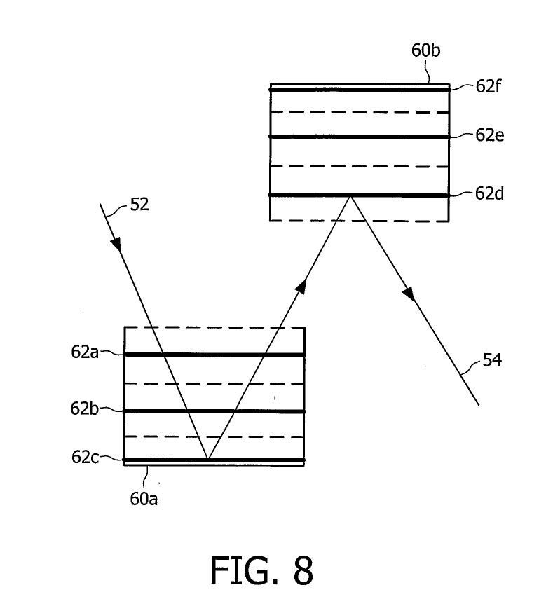

FIG. 8 is a schematic diagram of a cascaded optical path length adjuster deploying a combination of the adjusters of FIG. 6;

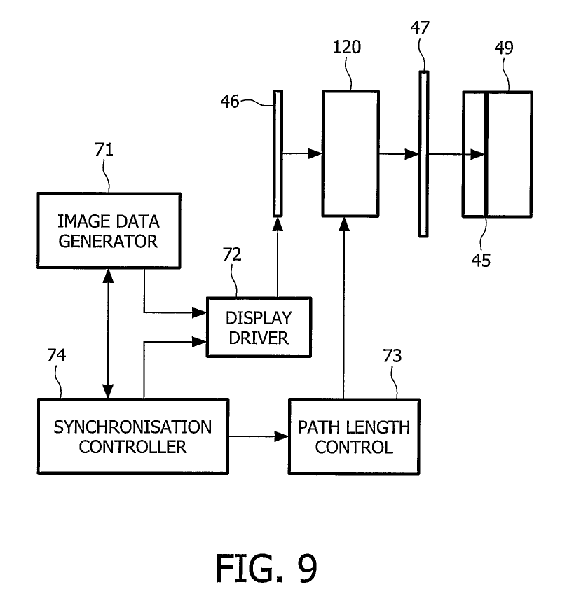

FIG. 9 is a schematic functional block diagram of a control system for the display device of FIG. 5.

FIGS. 3a and 3b illustrate some basic principles used in a three-dimensional image display device. In FIG. 3a, a relatively large virtual image 30 of a small display panel 31 is provided by a Fresnel mirror 32. In FIG. 3b, a relatively large virtual image 35 of a small display panel 36 is provided by a Fresnel lens 37. The virtual image 30 or 35 appears in the air in front of the lens. A spectator can focus on this image 30 or 35 and observes that it is ‘floating’ in the air.

FIGS. 4a and 4b illustrate a modification to the arrangements of FIGS. 3a and 3b. As shown in FIG. 4a, the effective optical path length between the display panel 41 and the Fresnel mirror 42 is varied by the provision of a suitable effective path length adjuster 43. Similarly, as shown in FIG. 4b, the effective optical path length between the display panel 46 and the Fresnel lens 47 is varied by the provision of a suitable effective path length adjuster 48.

In prior arrangements, the effective path length adjuster 43, 48 is a variable strength lens; in another arrangement, the effective path length adjuster is a mechanically-driven device which switches between two or more optical paths by physical movement of one or more optical elements.

The present invention, however, is directed toward electro-optically switching between two or more optical paths thereby avoiding a number of moving parts.

In a general sense, it will be noted that the mirror 42 or lens 47 may generally be replaced or implemented by any optical focusing element for projecting the two dimensional image of the display panel 41, 46 to a virtual image 40 or 45 located within an imaging volume 44 or 49. Preferably, the mirror 42 or lens 47 is a single or compound optical focusing element having a single focal length such that a planar display panel is imaged into a single plane of an imaging volume.

FIG. 5 illustrates the basic components of the display device 50 according to the principles of FIG. 4. A two-dimensional display device or ‘light engine’ 51 provides an illumination source for imaging at an image plane 55. The light travels along an input optical path 52 to an optical path length adjuster 53, and from the optical path length adjuster 53 via output optical path 54 to a focusing element 57 (e.g. mirror 42 or lens 47) which projects the two dimensional image to plane 55.

Operation of the optical path length adjuster 53 effectively moves the depth position of the image plane 55 as indicated by arrow 58. The path length is preferably adjusted periodically at a 3D image display frame frequency. Typically this would be 50 or 60 Hz. Referring back to FIG. 4, during one 3D image frame period (e.g. 1/50 sec), the virtual image of the display panel 41 or 46 fills the imaging volume 44 or 49. Within the same frame period, the display panel may be driven to alter the image that is projected, so that different depths within the imaging volume 44 or 49 receive different virtual images.

It will be understood that in a preferred aspect, the path length adjuster 53 is effective to periodically sweep a substantially planar virtual image of the substantially planar two dimensional display panel through the imaging volume 44 or 49 at a 3D frame rate. Within that 3D frame period, the 2D image display panel displays a succession of 2D images at a 2D frame rate substantially higher than the 3D frame rate.

Therefore, at different planes 40a, 40b or 45a, 45b in the imaging volume 40, 45, different images are obtained so that a three-dimensional image of any object can be constructed.

The two-dimensional display panel may be any suitable display device for creating a two dimensional image. For example, this could be a poly-LED display or a projection display based on a digital micromirror device (DMD).

Preferably, the display panel is sufficiently fast to enable the generation of plural 2D images within one frame period of, e.g. 1/50 sec. For example, commercially available DMDs can reach speeds of 10,000 frames per second. If 24 two-dimensional frames are used to create colour and grey-scale effects and a 3D image refresh rate of 50 Hz is required, it is possible to create eight different image planes 40a, 40b, 45a, 45b in the imaging volume 44, 49.

With reference to FIGS. 6 and 7, there is shown an optical path length adjuster 53 according to a preferred arrangement of the present invention. The optical path length adjuster 53 is based on polarising switches 61 and reflective polarisers 62.

In preferred arrangements the switches 61 and polarisers 62 are arranged in alternating sequence to form a layered stack 60. There is preferably one polarisation switch 61 for each reflective polariser 62 within the stack 60. The expression ‘polarisation switch’ is used herein to encompass any suitable device for selecting as output a specific polarisation state, e.g. a polarisation rotator that can be switched on and off. The polarisation switch 61 may be a single cell liquid crystal panel with a twisted nematic 90 degree structure or a ferro-electric effect cell which allows a higher switching speed. The polarisation switch 61 generally provides a polarised optical output in one of two possible polarisation states, according to an applied electric field.

The expression ‘reflective polariser’ is used herein to encompass any suitable device that transmits light with one polarisation and reflects light with the other (orthogonal) polarisation. Examples of reflective polarisers include, but are not limited to, cholesteric polarisers, wire grid polarisers and reflective display films, such as Vikuiti™ film manufactured by 3M (www.3m.com). The former is intended for use with circularly polarised light, while the latter two are for use with linearly polarised light.

In preferred arrangements, the reflective polariser 62 is a wire grid polariser 62a, 62b, 63c. Wire grid polarisers 62a, 62b, 63c have been in use for some time in the microwave region of the electromagnetic spectrum, however, recently wire grid polarisers 62a, 62b, 63c for use in the visible region have been introduced commercially by a company called Moxtek (http://www.moxtek.com). The theory behind the wire grid polarisers 62a, 62b, 63c is based on electromagnetic induction and wave interference, and is summarised below.

The function of the wire grid is to allow a light beam incident on the parallel wires having a polarisation state orthogonal to the direction of the wires to be transmitted through the grid. This arises since the electric field of the light beam being orthogonal to the wires cannot generate a significant current in the wires. However, an incident light beam having a polarisation state parallel to the direction of the wires can generate a significant current in the wires to excite electrons in the wires so as to radiate light in both forward and rearward directions. The forward radiated light cancels the light moving in the forward direction and the rearward radiated light emerges as a reflected wave.

In preferred arrangements, the wire grid polarisers 62a, 62b, 63c are arranged in the stack 60 so as to have parallel planes and such that the direction of the wires are orthogonal to the direction of the wires of a preceding wire grid polariser e.g. 62a and 62b.

Alternatively, in other preferred arrangements, the wire grid polarisers 62a, 62b, 63c are arranged in the stack 60 such that the direction of the wires are parallel to the direction of the wires of a preceding wire grid polariser.

The switches 61 and polarisers 62 can preferably be mounted on a transparent substrate 63 for stability and support, with the switch/substrate combination 61, 63 forming one type of layer and the polariser/substrate 62, 63 forming another type of layer. The substrate 63 can be any suitable rigid and transparent material having a low coefficient of thermal expansion and includes, but is not limited to, glass and Perspex. Preferably, the two types of layers in the stack 60 can either be in contact with adjacent layers or else be spaced apart and separated by an intervening medium such as, but not limited to, air, vacuum or other transparent medium.

Any suitable adhesive or bonding agent which is transparent when set (i.e. dry) may be used to bond the layers in the stack 60. Alternatively, the layers of the stack may be held together by any suitable mechanical device which operates so as to either permanently or removeably clamp the layers securely together.

In arrangements in which the reflective polariser 62 is a reflective film, the film typically includes an adhesive layer enabling simple adhesion of the polariser to substrates 63 in the stack 60.

In preferred arrangements the stack 60 is constructed with layers which are bonded to each other since the stack 60 is easier to handle and more robust than a separated layer stack. Additionally, the manufacture of a bonded layer stack is easier since the stack can be fabricated as a single device. Hereinafter references to ‘stack’ are taken to refer to both bonded and separated layer stack arrangements, however it is to be understood that the exemplary arrangement is directed to a bonded layer stack 60.

The stack 60 has a face layer which preferably comprises a polarisation switch. Light is input to the stack 60 along an input optical path 52 which enters the stack 60 through the face layer. The lowest layer in the stack 60 is the base layer which operates so as to always reflect incident light. Preferably this is a plane mirror, but may alternatively be a reflective polariser 62 provided the polarisation state of the incident light on that layer is selected such that reflection will always occur.

Referring to FIG. 7, there is shown a schematic diagram of an exemplary stack arrangement showing possible optical paths within the stack 60. In this arrangement, the wire grid polarisers 62a, 62b, 62c are arranged so as to have alternating orthogonal wire directions. By way of example, in FIG. 7a let us assume that we start with an input beam of polarised light on input path 52, for instance with polarisation state S (shown as circles on the input path, the circles denoting the electric field vector of the light is normal to the plane of the page). By means of the polarisation switch 61a, it is possible to determine the polarisation state of the input beam i.e. to either change or maintain the polarisation state so as to select a preferred polarisation. In FIG. 7a the liquid crystal cell is switched off and so the input beam maintains a polarisation state S after passing through the cell. The wire grid polariser 62a is arranged so that the wires run in a direction which is normal to the plane of the page as shown.

Hence, since the input beam is S-polarised in the direction of the wires, the wire grid polariser 62a acts as a reflector and so the input beam is reflected back from the wire grid polariser 62a and emerges on the output optical path 54a. In this instance, the polarisation state of the incident beam is selected so as to correspond to the direction of the wires of the wire grid polariser 62a, thereby rendering this particular wire grid polariser 62a as the reflecting layer.

In FIG. 7b, if the first polarisation switch 61a is switched on, the S-polarised input light beam will be converted to P-polarised after passing through the cell 61a (as shown by short parallel marks on the input path, the marks denoting the electric field vector of the light is in the plane of the page). Since the wire grid polariser 62a is arranged as before, with the wires normal to the plane of the page, the P-polarised light is transmitted by the wire grid polariser 62a. As the second liquid crystal cell 61b is switched off, the polarisation state of the transmitted beam is maintained. The transmitted beam passes through the cell 61b and is incident on the second wire grid polariser 62b in the stack 60. However, since the wire grid polarisers are arranged so that each sequential wire grid polariser is orthogonal with respect to the preceding one, the polarisation state of the transmitted light beam in this instance is parallel to the wires.

Hence, the second wire grid polariser 62b acts as a reflector and so the transmitted beam is reflected back from the second wire grid polariser 62b, passing through the layers 61b, 62a, 61a and emerging on the output optical path 54b. In this instance, the polarisation state of the transmitted beam is selected so as to correspond to the direction of the wires of the second wire grid polariser 62b, thereby rendering this particular wire grid polariser 62b as the reflecting layer. Clearly, this time the input light beam traverses the stack 60 to a greater depth d₁, thereby varying the optical path length between the input optical path 52 and the output optical path 54b by ≈2d₁, relative to the first example.

In FIG. 7c, the example is the same as in FIG. 7b up to the point where the P-polarised beam transmitted by the first wire grid polariser 62a is incident on the second liquid crystal cell 61b. Here, the second liquid crystal cell 61b is switched on, so the polarisation state of the transmitted beam is changed from P-polarised to S-polarised. The second wire grid polariser 62b is arranged such that incident S-polarised light is transmitted, so the S-polarised beam passes through the second wire grid polariser 62b. A third liquid crystal cell 61c is switched off, so the polarisation state of the S-polarised transmitted beam is maintained as the beam passes through the cell 61c. However, the third wire grid polariser 62c is arranged so that the wires run in a direction normal to the page as shown and so the polarisation state of the transmitted light beam is parallel to the wire direction.

Hence, the third wire grid polariser 62c acts as a reflector and so the transmitted beam is reflected back from the third wire grid polariser 62c, passing through the layers 61c, 62b, 61b, 62a, 61a and emerging on the output optical path 54c. In this instance, the polarisation state of the transmitted beam is selected so as to correspond to the direction of the wires of the third wire grid polariser 62c, thereby rendering this particular wire grid polariser 62c as the reflecting layer. In this example the input light beam traverses the stack to a depth d₁+d₂, thereby varying the effective optical path length between the input optical path 52 and the output optical path 54 by a distance ≈2(d₁+d₂), which is further than the optical path length of the second example.

It will be appreciated that the distance travelled by an input light beam in passing between two layers spaced by a distance d will be somewhat dependent on the angle of incidence of the beam. Only for normal incidence will the distance travelled be exactly equal to d. For more oblique angles of incidence the distance travelled will be >d. Hence, in the previous example in which reflection occurs, the effective optical path length between the input optical path 52 and the output optical path 54 would be equal to 2(d₁+d₂) for normal incidence and would be >2(d₁+d₂) for increasing angles of incidence.

If the wire grid polarisers 62a, 62b, 62c had been arranged such that the direction of the wires were parallel to the direction of the wires of a preceding wire grid polariser, the operation of the polarisation switches 61a, 61b, 61c must be adapted accordingly. In either case, the function of the polarisation switches 61a, 61b, 61c is to select the polarisation state of a beam incident on a particular wire grid polariser, so that the beam is either transmitted or reflected dependent on the direction of the wires.

In arrangements in which the reflective polarisers in the stack 60 are cholesteric polarisers, the polarisation switches 61a, 61b, 61c provide either 180 degrees or 0 degrees retardation, either changing the handedness of the light beam or else leaving it unchanged at each respective polarisation switch layer.

As a consequence of allowing the input light beam to be successively transmitted through further layers of the stack 60, the effective optical path length can be increased between the input optical path 52 and the output optical path 54. The effective optical path length can be varied by simply selecting a desired depth within the stack 60 at which reflection is to occur from a particular reflective polariser 62. All of this can be achieved without any moving parts.

It will be appreciated that the lengths of available optical paths within a particular stack 60 can be pre-selected by choosing the thicknesses of the substrates 63 supporting the polarisation switches 61 and reflective polarisers 62. In preferred arrangements, the thicknesses of the substrates 63 may be the same or alternatively may be varied. Hence, multiple effective optical path lengths within a stack 60 are available by preferably selecting particular combinations of layers having the same or varying thicknesses. Due to the nature of the stack 60 and the operation of the reflective polarisers 62, there is one output optical path 54a, 54b, 54c for each reflective polariser 62a, 62b, 62c. Each successive reflective polariser 62a, 62b, 62c gives rise to a respective output optical path 54a, 54b, 54c which is laterally displaced and parallel to the output optical paths 54a, 54b, 54c of the other reflective polarisers 62a, 62b, 62c. This condition does not apply to normal incidence of the input beam however, where output paths are coincident.

In other preferred arrangements, the lengths of available optical paths within a particular stack 60 can be pre-selected by choosing the refractive indices of the substrates 63. The refractive indices of the substrates 63 can preferably be the same for all substrates 63 or else be different for different substrates 63. By selecting a particular refractive index for a particular substrate 63, the input light beam can be refracted so as to traverse a longer optical path through the substrate 63, relative to another substrate 63 of the same thickness but different refractive index.

It will be appreciated that, in preferred arrangements, the base layer will only ever receive incident light if each reflective polariser 62 in the stack 60 transmits the light incident on it, or put another way, if none of the reflective polarisers 62 are selected to reflect the incident light.

By means of the example adjuster in FIG. 7, we can create three image planes 55 in a volumetric display device 50. With each successive reflective polariser 62 in the stack 60 an additional image plane may preferably be created.

Further planes 55 can be created by means of more than one adjuster 53 in a cascade arrangement, as shown in FIG. 8. This is one example of a preferred cascade arrangement comprising two stacks 60a, 60b having opposing face layers. By selecting a particular combination of reflective polariser in the first stack and reflective polariser in the second stack, multiple effective optical lengths can be selected through the cascade arrangement. In the example illustrated, one of the many optical paths in the arrangement is defined by selecting the third reflective polariser 62c of the first stack 60a and the first reflective polariser 62d of the second stack 60b to each be reflective. By selecting the required polarisation states of an input beam as the beam traverses the arrangement, the beam can reflect from the selected layers and follow the desired optical path as shown. It will be appreciated that any number of adjusters 53 can be cascaded in this way to provide further effective optical path lengths, leading to further image planes 55.

It will be appreciated that the stacks 60a, 60b in a cascade arrangement need not be identical in terms of number of layers, substrate thicknesses and refractive indices.

The different effective optical paths might result in brightness differences due to absorption coefficients of the polarisation switches 61 and/or reflective polarisers 62. This absorption could be compensated for by the intensity of light engine display 51, e.g. corrected electronically in a video signal supplied thereto.

With reference to FIG. 9 a schematic view of an overall volumetric image display device using the optical path length adjusters described herein, together with control system, is shown. The path length adjuster 120 (e.g. adjuster 53 as described earlier) interposed between the 2D display panel 46 and focusing element 47 is controlled by path length control circuit 73. Path length control circuit provides electrical drive signals to each of the polarisation switches, e.g. 61a, 61b, 61c. A display driver 72 receives 2D frame image data from image generator 71. Display of the succession of 2D images is synchronised with the path length controller operation by way of a synchronisation circuit 74.

Although a principal and important use for the path length adjuster as described herein is in the application of a volumetric three dimensional image display device, it will be recognised that the adjuster may have use in other optical instruments and devices, where it is necessary or desirable to facilitate the electro-optical switching of an optical path length between two optical elements. Such an arrangement avoids the need for moving parts as the path length can be varied by way of electrical control signals to each of the polarisation switches.

Other embodiments are intentionally within the scope of the accompanying claims.

1. An optical path length adjuster (53) for varying an optical path length between an input optical path (52) and an output optical path (54), comprising:
a plurality of first optical elements (61) and second optical elements (62) arranged in alternating sequence along an optical path, each first optical element for determining a polarisation state of a light beam passing through that element and each second optical element for selectively transmitting or reflecting a light beam incident on that element depending on the selected polarisation state of the incident light beam,
wherein the optical path length traversed by an input beam on the optical path can be varied by selecting a particular second optical element at which reflection of the input beam is to occur, the reflected input beam emerging along the output optical path.

2. The adjuster of claim 1, further comprising a plurality of different spacings between adjacent first (61) and second optical elements (62).

3. The adjuster of claim 2, wherein the spacings between adjacent first (61) and second (62) optical elements have different thicknesses depending on the optical path lengths required along the optical path.

4. The adjuster of claim 2, wherein the spacings between adjacent first (61) and second (62) optical elements are occupied by spacing media.

5. The adjuster of claim 4, wherein the spacing media between adjacent first (61) and second (62) optical elements have different refractive indices depending on the optical path lengths required along the optical path.

6. The adjuster of claim 4, wherein the spacing media between adjacent first (61) and second (62) optical elements includes glass substrates (63).

7. The adjuster of claim 1, wherein the plurality of first optical elements (61) and second optical elements (62) are arranged in a layered stack configuration (60).

8. The adjuster of claim 1, wherein the first optical element (61) comprises a polarising switch (61a, 61b, 61c) capable of changing the polarisation state of a light beam passing through the element.

9. The adjuster of claim 8, wherein the polarising switch (61a, 61b, 61c) is supported by a glass substrate (63).

10. The adjuster of claim 8, wherein the polarising switch (61a, 61b, 61c) is a liquid crystal cell.

11. The adjuster of claim 1, wherein the second optical element (62) comprises a wire grid polariser (62a, 62b, 62c).

12. The adjuster of claim 11, wherein the wire grid polariser (62a, 62b, 62c) is supported by a glass substrate (63).

13. The adjuster of claim 1, wherein the second optical element (62) comprises a cholesteric polariser.

14. The adjuster of claim 13, wherein the cholesteric polariser is supported by a glass substrate (63).

15. The adjuster of claim 11, wherein consecutive wire grid polarisers (62a, 62b, 62c) are arranged so as to have parallel planes and such that the direction of the wires are orthogonal to the direction of the wires of the preceding wire grid polariser.

16. The adjuster of claim 7, wherein the input beam enters the stack (60) through a face layer of the stack, the face layer being a said first optical element (61).

17. The adjuster of claim 16, wherein the stack (60) has a base layer which is reflective only.

18. The adjuster of claim 17, wherein the base layer is a plane mirror.

19. The adjuster of claim 17, wherein the output beam leaves the stack (60) through the face layer, the output beam resulting from reflection by either a selected second optical element (62) or the base layer.

20. The adjuster of claim 1, wherein the spacing (d₁, d₂) between sequential second optical elements (62) determines the possible optical path lengths along the optical path.

21. The adjuster of claim 1 combined with at least one further optical path length adjuster of claim 1 in a cascade formation, such that the output optical path (54) of the first said optical path length adjuster (53) forms the input path (52) of a successive said further optical path length adjuster.

22. A display device for generating a three-dimensional volumetric image, comprising:
a two-dimensional image display panel (41, 46) for generating a two-dimensional image;
a first focusing element (42, 47) for projecting the two-dimensional image to a virtual image (40, 45) in an imaging volume (44, 49); and
means (43, 48, 53) for altering the effective optical path length between the display panel and the projecting first focusing element so as to alter the position of the virtual image within the imaging volume, wherein the means for altering the effective optical path length comprises the optical path length adjuster according to claim 1.

23. A method for varying an optical path length between an input optical path (52) and an output optical path (54) of an optical path length adjuster (53), comprising the steps of:
providing an input beam of light on the input optical path and passing it into a plurality of first optical elements (61) and second optical elements (62) arranged in alternating sequence along the optical path;
determining a polarisation state of the input beam at each first optical element through which the beam passes; and
either transmitting or reflecting the beam at each second optical element (62) on which the beam is incident, depending on the selected polarisation state of the incident beam;
wherein the optical path length traversed by the input beam on the optical path can be varied by selecting a particular second optical element (62) at which reflection of the input beam is to occur, the reflected input beam emerging along the output optical path.

24. The method of claim 23, in which the determining step either changes or maintains the polarisation state of the beam, so as to select a preferred polarisation state.

25. The method of claim 24, in which the polarisation state of the beam is changed by switching a polarising switch (61a, 61b, 61c) in the first optical element (61) from one polarising state to another polarising state.

26. The method of claim 24, in which a preferred polarisation state is selected for each second optical element (62) on which the beam is incident, so as to correspond to a polarisation state which is either transmitted or reflected by each particular second optical element (62).

27. The method of claim 23, in which the second optical element (62) comprises a wire grid polariser (62a, 62b, 62c) and the preferred polarisation state is selected so as to be parallel to the direction of the wires if the beam is to be reflected and orthogonal to the direction of the wires if the beam is to be transmitted.

28. The method of claim 27, in which consecutive second optical elements (62) are arranged so that the direction of the wires of the wire grid polariser (62a, 62b, 62c) are orthogonal to the direction of the wires of a preceding wire grid polariser.

29. The method of claim 1, in which the optical path length is dependent on at least the number of second optical elements (62) which transmit the beam and the spacings (d₁, d₂) therebetween.

30. The method of claim 1, in which arranging the plurality of first optical elements (61) and second optical elements (62) in alternating sequence produces a layered stack configuration (60), having a face layer corresponding to a first optical element and a base layer which only reflects.

31. The method of claim 30, in which the arranging places the layers in contact with each other or holds the layers in spaced relation.

32. The method of claim 30, in which the optical path length depends on at least the position of the layer within the stack which includes the particular second optical element (62) selected to reflect the beam.

33. The method of claim 30, in which the beam is reflected from the base layer if each of the second optical elements (62) transmits the beam.

34. The method of claim 23 further including passing light from the output optical path (54, 54a, 54b, 54c) to an input optical path (52) of a downstream optical path length adjuster and repeating the steps for adjusting the optical path length.

35. The method of claim 34 further including the step of selecting different optical path lengths within each said optical path length adjuster.

36. A method for generating a three-dimensional volumetric image, comprising the steps of:
generating a two-dimensional image on a two-dimensional image display panel (41, 46);
projecting the two-dimensional image to a virtual image (40, 45) in an imaging volume (44, 49) with a first focusing element (42, 47); and
altering the optical path length between the display panel and the projecting focusing element so as to vary the position of the virtual image within the imaging volume according to the method of claim 31.

37. An optical path length adjuster substantially as described herein with reference to the accompanying FIGS. 6 to 9.

38. A method for varying an optical path length between an input optical path (52) and an output optical path (54) of an optical path length adjuster (53) substantially as described herein with reference to the accompanying FIGS. 6 to 9.
